(19) United States
(12) Patent Application Publication
(10) Pub. No.: US 2025/0272212 A1
(43) Pub. Date: Aug. 28, 2025

(54) CROSS-PLATFORM ELECTRONIC CONTROL UNIT RESOURCE MONITOR AND BENCHMARK SUITE FOR VEHICLE HARDWARE ENGINEERING

(71) Applicant: FCA US LLC, Auburn Hills, MI (US)

(72) Inventors: Dong Yang, Troy, MI (US); Haikuan Qiu, Novi, MI (US)

(21) Appl. No.: 18/589,557

(22) Filed: Feb. 28, 2024

(51) Int. Cl. G06F 11/34

(52) U.S. Cl. CPC G06F 11/3409; G06F 11/3466

(57) ABSTRACT

A hardware monitoring system for a control system of a vehicle includes a plurality of microcontrollers of the control system, each of the plurality of microcontrollers having been loaded with an embedded software application and configured to execute the embedded software application according to a defined set of execution parameters and, during execution of the embedded software application, generate raw key performance indicator (KPI) data indicative of a set of KPI metrics, and a client computing system associated with a hardware engineer and configured to obtain the raw KPI data for the plurality of microcontrollers and generate a visualized display representative of a side-by-side comparison of the raw KPI data for each of the plurality of microcontrollers.

### FIELD

The present application generally relates to vehicle hardware engineering and, more particularly, a cross-platform electronic control unit (ECU) resource monitor and benchmark suite for vehicle hardware engineering.

### BACKGROUND

Today's vehicles are becoming more complex and have a plurality of different electronic control units (ECUs) or system-on-chips (SOCs). Some non-limiting examples of these different controllers/modules include motor control processors (MCPs), engine control modules (ECMs), transmission control modules (TCMs), and advanced driver-assistance (ADAS) and autonomous driving system control modules. This makes the job of hardware engineers, who select/source the ECUs from different suppliers, very difficult, as it requires them to optimize performance while also minimizing costs. Most ECUs have limited software tools that allow hardware engineers to view limited key performance indicators (KPIs), such as processor and memory usage. These tools, however, are limited to that vendor's products, and thus the tools fail to provide an “apples-to-apples” comparison for hardware engineers. Accordingly, while such conventional vehicle ECU resource monitoring solutions do work for their intended purpose, there exists an opportunity for improvement in the relevant art.

### SUMMARY

According to one example aspect of the invention, a hardware monitoring system for a control system of a vehicle is presented. In one exemplary implementation, the hardware monitoring system comprises a plurality of microcontrollers of the control system, each of the plurality of microcontrollers having been loaded with an embedded software application and configured to execute the embedded software application according to a defined set of execution parameters and, during execution of the embedded software application, generate raw key performance indicator (KPI) data indicative of a set of KPI metrics, and a client computing system associated with a hardware engineer and configured to obtain the raw KPI data for the plurality of microcontrollers and generate a visualized display representative of a side-by-side comparison of the raw KPI data for each of the plurality of microcontrollers.

In some implementations, the set of KPI metrics include at least one of (i) processor usage, (ii) random access memory (RAM) usage, (iii) universal flash (UFS) usage and lifespan, (iv) system-on-chip (SOC) thermal performance, (v) chip-to-chip (C2C) performance, (vi) Ethernet performance, and (vii) sensor statuses. In some implementations, the set of KPI metrics include (i) processor usage, (ii) RAM usage, (iii) UFS usage and lifespan, (iv) SOC thermal performance, (v) C2C performance, (vi) Ethernet performance, and (vii) sensor statuses.

In some implementations, the hardware monitoring system further comprises a Linux Ubuntu configured computing system configured to develop and generate the embedded software application. In some implementations, the embedded software application is loaded into the plurality of microcontrollers using a secured shell (SSH) protocol. In some implementations, at least some of the plurality of microcontrollers are configured to receive the embedded software application via a serial port. In some implementations, the defined set of execution parameters includes loading all processors and processing cores to a maximum usage rate.

In some implementations, at least some of the plurality of microcontrollers are manufactured by different microcontroller suppliers. In some implementations, the hardware monitoring system further comprises a server computing system configured to receive the raw KPI data for the plurality of microcontrollers via a network, store the raw KPI data as a set of raw KPI data files, and output the set of raw KPI data files to the client computing system in response to an authorized request. In some implementations, the raw KPI data files are a set of .JPG or .CSV files, and wherein the client computing system is configured to execute any suitable operating system and a Javascript for a data processing visual library as part of the generating of the visualized display.

According to another example aspect of the invention, a hardware monitoring method for a control system of a vehicle is presented. In one exemplary implementation, the hardware monitoring method comprises loading, by each of a plurality of microcontrollers of the control system, an embedded software application, executing, by each of the plurality of microcontrollers, the embedded software application according to a defined set of execution parameters, during execution of the embedded software application, generating, by the plurality of microcontrollers, raw KPI data indicative of a set of KPI metrics, obtaining, by a client computing system associated with a hardware engineer, the raw KPI data for the plurality of microcontrollers, and generating, by the client computing system, a visualized display representative of a side-by-side comparison of the raw KPI data for each of the plurality of microcontrollers.

In some implementations, the set of KPI metrics include at least one of (i) processor usage, (ii) RAM usage, (iii) UFS usage and lifespan, (iv) SOC thermal performance, (v) C2C performance, (vi) Ethernet performance, and (vii) sensor statuses. In some implementations, the set of KPI metrics include (i) processor usage, (ii) RAM usage, (iii) UFS usage and lifespan, (iv) SOC thermal performance, (v) C2C performance, (vi) Ethernet performance, and (vii) sensor statuses.

In some implementations, the hardware monitoring method further comprises developing and generating, by a Linux Ubuntu configured computing system, the embedded software application. In some implementations, the embedded software application is loaded into the plurality of microcontrollers using an SSH protocol. In some implementations, at least some of the plurality of microcontrollers are configured to receive the embedded software application via a serial port. In some implementations, the defined set of execution parameters includes loading all processors and processing cores to a maximum usage rate.

In some implementations, at least some of the plurality of microcontrollers are manufactured by different microcontroller suppliers. In some implementations, the hardware monitoring method further comprises receiving, by a server computing system and from the plurality of microcontrollers via a network, the raw KPI data for the plurality of microcontrollers, storing, by the server computing system, the raw KPI data as a set of raw KPI data files, and outputting, by the server computing system and to the client computing systems via the network or another network, the set of raw KPI data files in response to an authorized request. In some implementations, the raw KPI data files are a set of .JPG or .CSV files, and wherein the client computing system is configured to execute any suitable operating system and a Javascript for a data processing visual library as part of the generating of the visualized display.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having a control system and an example hardware monitoring system for the control system according to the principles of the present application;

FIG. 2 is a feature development and dataflow diagram for the example hardware monitoring system according to the principles of the present application; and

FIG. 3 is a flow diagram of an example hardware monitoring method for a control system of a vehicle according to the principles of the present application.

### DESCRIPTION

As previously discussed, today's vehicles have a plurality of electronic control units (ECUs) that are often selected/sourced by hardware engineers from different suppliers. This makes the job of hardware engineers very difficult, as it requires them to optimize performance while also minimizing costs. Most ECUs have limited software tools that allow hardware engineers to view limited key performance indicators (KPIs), such as processor and memory usage. These tools, however, are limited to that vendor's products, and thus the tools fail to provide an “apples-to-apples” comparison for hardware engineers. Accordingly, improved hardware monitoring systems and methods for control systems of vehicles are presented herein. These systems and methods primarily include the development of an embedded software that is loaded into and executable by various microcontroller (MCUs) of the vehicle. This embedded software is designed with specific scripts/binary for data collection, performance measurement, and simulations to stress hardware limits. The ECUs/MCUs can then execute the embedded software to generate raw KPI data. This KPI data could be uploaded to the cloud (e.g., a server system) and then downloadable by client devices (e.g., engineer computer devices) as a KPI data dump or could be sent directly to the client devices.

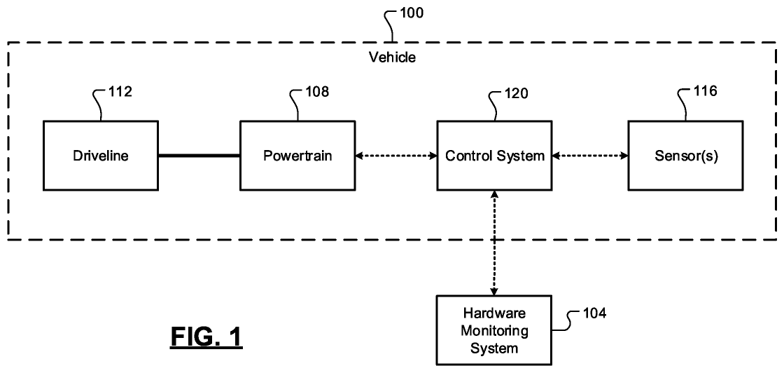

Referring now to FIG. 1, a functional block diagram of a vehicle 100 having a control system 120 and an example hardware monitoring system 104 for the control system 120 according to the principles of the present application is illustrated. The vehicle 100 primarily includes a powertrain 108 configured to generate and transfer drive torque to a driveline 112 for vehicle propulsion. Non-limiting examples of the components of the powertrain 108 include an electric traction motor, an internal combustion engine, an electric motor-generator unit, and combinations thereof (engine only, hybrid, all-electric, etc.). A plurality of sensors 116 are configured to measure operating parameters of the vehicle 100, including a driver torque request (e.g., provided by a driver via an accelerator pedal), which are used by the control system 120 to control the powertrain 108. The control system 120 includes a plurality of different ECUs or MCUs arranged in any suitable configuration (e.g., on a complex controller area network, or CAN). The hardware monitoring system 104 is configured to monitor the performance of the hardware of the control system 120 as discussed in greater detail below.

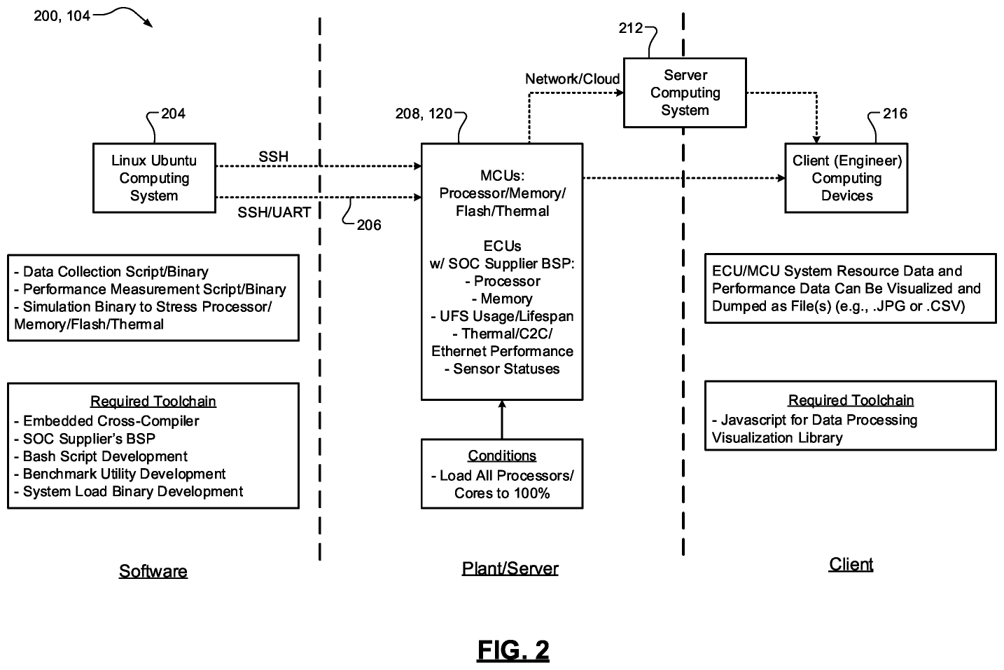

Referring now FIG. 2 and with continued reference to FIG. 1, a feature development and dataflow diagram 200 for one the example hardware monitoring system 104 according to the principles of the present application is illustrated. The hardware monitoring system 104 can be generally divided into three phases of dataflow or feature development: software, plant/server, and client. In the software stage, the embedded software application is developed or designed. This could occur at, for example, a Linux computing system executing an Ubuntu operating system (also referred to herein as a Linux Ubuntu configured computing system 204). The embedded software application is a script or binary code designed for (1) data collection, (2) performance measurement, and (3) simulation to stress processor/memory/flash/thermal. In some cases, a required toolchain is proposed for developing and loading the embedded software application into the ECUs/MCUs 208. In one exemplary implementation, the required toolchain includes (i) an embedded cross-compiler, (ii) the SOC supplier's board support package (BSP), (iii) bash script development, (iv) benchmark utility development, and (v) system load binary development.

In the plant/server stage, the ECUs/MCUs 208 (of the control system 112) have the embedded software application loaded thereon, e.g., via a secure shell (SSH) protocol, such as via a serial port 206. The MCUs are configured to generate raw KPI data indicative of processor/memory/flash/thermal usage. The ECUs, with the SOC supplier BSP, are configured to generate raw KPI data indicative of the processor usage, memory usage, universal flash (UFS) usage/lifespan, thermal/C2C/Ethernet performance, and sensor statuses. In some implementations, the ECUs/MCUs 208 are configured to execute the embedded software applications at specific operating conditions. For example only, as shown, these conditions could be all the processors or processor cores being at a maximum level, which could be 100% or within a threshold amount from 100%. The execution of the embedded software applications generates all of this raw KPI data (for each ECU/MCU 208), which is then output. In one exemplary implementation, this information is uploaded (via a network) to a server computing system 212 where it is stored and then is retrievable thereafter by authorized requesting client devices. Alternatively, the ECUs/MCUs 208 could be configured to directly output the raw KPI data to the client device(s) 216.

In the third client stage, the client (hardware engineer) computing devices 216 are configured to request to download or otherwise retrieve the KPI data for the ECUs/MCUs 208. This raw KPI data could be providable in a single files or group of files, such as in .JPG or .CSV formats. In one exemplary implementation, a required toolchain is the client computing devices 216 executing any desirable operating system (i.e., not OS-limited) and a Javascript for a data processing visualization library. This allows the client computing devices 216 to generate and display a visual representation of the KPI data for the ECUs/MCUs 208 in a side-by-side comparison (e.g., “apples-to-apples comparison”) for use by the hardware engineers to optimize the hardware for the vehicle 100. It will be appreciated that this diagram 200 is merely one example configuration of the hardware monitoring system 104 and that the hardware monitoring system 104 could include minor differences compared to what is illustrated (e.g., a different computing station configuration for the embedded software application development). It will also be appreciated that the usage of this hardware monitoring system 104 could be limited to a calibration/development (pre-vehicle launch) environment where the hardware engineers are still analyzing different hardware combinations before deciding on a final hardware configuration for vehicle production.

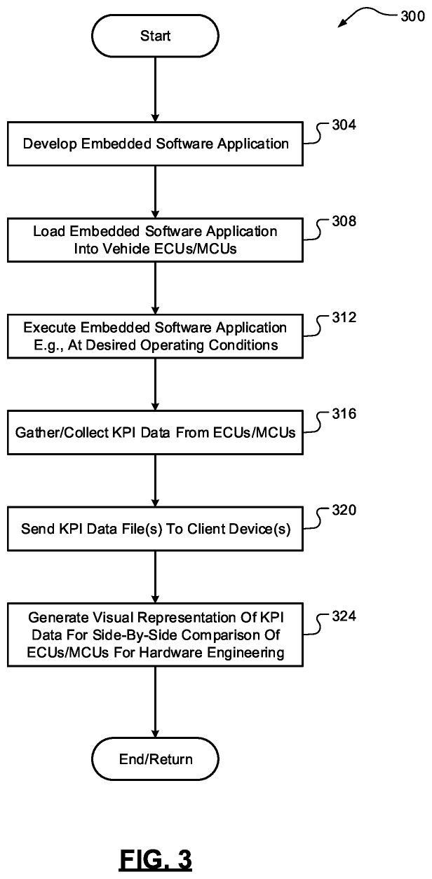

Referring now to FIG. 3, a flow diagram of an example hardware monitoring method 300 for a control system of a vehicle according to the principles of the present application. While the vehicle 100 and its components are specifically referenced for illustrative/descriptive purposes, it will be appreciated that the method 300 could be applicable to any suitably configured vehicle in a calibration (pre-launch) environment. The method 300 begins at 304 where the embedded software application is developed or designed (e.g., on a Linux Ubuntu computing system) as previously described herein. At 308, the embedded software application is loaded into the ECUs/MCUs 208 of the control system 112 as previously discussed herein. At 312, the ECUs/MCUs 208 execute the embedded software application, which could be at specific operating conditions (e.g., 100% processor/core load) as previously described herein.

At 316, the raw KPI data is gathered/collected for the ECUs/MCUs 208 and stored, such as at the server computing system 212. At 320, the KPI data is sent/distributed to authorized client (hardware engineer) computing devices 216 (e.g., in file(s) having a .JPG or .CSV format). At 324, the client computing devices 216 process the KPI data (e.g., using a Javascript for a data processing visualization library) to generate a visual representation thereof, which represents a side-by-side comparison of the KPI data for the various ECUs/MCUs 208. The method 300 then ends or returns to 304 for one or more additional cycles.

It will be appreciated that the terms “controller” and “control system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A hardware monitoring system for a control system of a vehicle, the hardware monitoring system comprising:
a plurality of microcontrollers of the control system, each of the plurality of microcontrollers having been loaded with an embedded software application and configured to:
execute the embedded software application according to a defined set of execution parameters; and
during execution of the embedded software application, generate raw key performance indicator (KPI) data indicative of a set of KPI metrics; and
a client computing system associated with a hardware engineer and configured to:
obtain the raw KPI data for the plurality of microcontrollers; and
generate a visualized display representative of a side-by-side comparison of the raw KPI data for each of the plurality of microcontrollers.

2. The hardware monitoring system of claim 1, wherein the set of KPI metrics include at least one of (i) processor usage, (ii) random access memory (RAM) usage, (iii) universal flash (UFS) usage and lifespan, (iv) system-on-chip (SOC) thermal performance, (v) chip-to-chip (C2C) performance, (vi) Ethernet performance, and (vii) sensor statuses.

3. The hardware monitoring system of claim 1, wherein the set of KPI metrics include (i) processor usage, (ii) random access memory (RAM) usage, (iii) universal flash (UFS) usage and lifespan, (iv) system-on-chip (SOC) thermal performance, (v) chip-to-chip (C2C) performance, (vi) Ethernet performance, and (vii) sensor statuses.

4. The hardware monitoring system of claim 1, further comprising a Linux Ubuntu configured computing system configured to develop and generate the embedded software application.

5. The hardware monitoring system of claim 4, wherein the embedded software application is loaded into the plurality of microcontrollers using a secured shell (SSH) protocol.

6. The hardware monitoring system of claim 5, wherein at least some of the plurality of microcontrollers are configured to receive the embedded software application via a serial port.

7. The hardware monitoring system of claim 1, wherein the defined set of execution parameters includes loading all processors and processing cores to a maximum usage rate.

8. The hardware monitoring system of claim 1, wherein at least some of the plurality of microcontrollers are manufactured by different microcontroller suppliers.

9. The hardware monitoring system of claim 1, further comprising a server computing system configured to:
receive the raw KPI data for the plurality of microcontrollers via a network;
store the raw KPI data as a set of raw KPI data files; and
output the set of raw KPI data files to the client computing system, via the network or another network, in response to an authorized request.

10. The hardware monitoring system of claim 9, wherein the raw KPI data files are a set of .JPG or .CSV files, and wherein the client computing system is configured to execute any suitable operating system and a Javascript for a data processing visual library as part of the generating of the visualized display.

11. A hardware monitoring method for a control system of a vehicle, the hardware monitoring method comprising:
loading, by each of a plurality of microcontrollers of the control system, an embedded software application;
executing, by each of the plurality of microcontrollers, the embedded software application according to a defined set of execution parameters;
during execution of the embedded software application, generating, by the plurality of microcontrollers, raw key performance indicator (KPI) data indicative of a set of KPI metrics;
obtaining, by a client computing system associated with a hardware engineer, the raw KPI data for the plurality of microcontrollers; and
generating, by the client computing system, a visualized display representative of a side-by-side comparison of the raw KPI data for each of the plurality of microcontrollers.

12. The hardware monitoring method of claim 11, wherein the set of KPI metrics include at least one of (i) processor usage, (ii) random access memory (RAM) usage, (iii) universal flash (UFS) usage and lifespan, (iv) system-on-chip (SOC) thermal performance, (v) chip-to-chip (C2C) performance, (vi) Ethernet performance, and (vii) sensor statuses.

13. The hardware monitoring method of claim 11, wherein the set of KPI metrics include (i) processor usage, (ii) random access memory (RAM) usage, (iii) universal flash (UFS) usage and lifespan, (iv) system-on-chip (SOC) thermal performance, (v) chip-to-chip (C2C) performance, (vi) Ethernet performance, and (vii) sensor statuses.

14. The hardware monitoring method of claim 11, further comprising developing and generating, by a Linux Ubuntu configured computing system, the embedded software application.

15. The hardware monitoring method of claim 14, wherein the embedded software application is loaded into the plurality of microcontrollers using a secured shell (SSH) protocol.

16. The hardware monitoring method of claim 15, wherein at least some of the plurality of microcontrollers are configured to receive the embedded software application via a serial port.

17. The hardware monitoring method of claim 11, wherein the defined set of execution parameters includes loading all processors and processing cores to a maximum usage rate.

18. The hardware monitoring method of claim 11, wherein at least some of the plurality of microcontrollers are manufactured by different microcontroller suppliers.

19. The hardware monitoring method of claim 11, further comprising:
receiving, by a server computing system and from the plurality of microcontrollers via a network, the raw KPI data for the plurality of microcontrollers;
storing, by the server computing system, the raw KPI data as a set of raw KPI data files; and
outputting, by the server computing system and to the client computing systems via the network or another network, the set of raw KPI data files in response to an authorized request.

20. The hardware monitoring method of claim 19, wherein the raw KPI data files are a set of .JPG or .CSV files, and wherein the client computing system is configured to execute any suitable operating system and a Javascript for a data processing visual library as part of the generating of the visualized display.
